(19) United States
(12) Patent Application Publication
(10) Pub. No.: US 2026/0281246 A1
(43) Pub. Date: Sep. 17, 2026

(54) METHOD FOR COMMUNICATION IN A COMMUNICATION NETWORK

(71) Applicant: Tribe Technologies GmbH, Frankfurt am Main (DE)

(72) Inventors: Axel REDDEHASE, Frankfurt am Main (DE); Andreas HÄFERER, Mörfelden-Walldorf (DE)

(21) Appl. No.: 19/469,756

(22) PCT Filed: Mar. 22, 2024
(86) PCT No.: PCT/EP2024/057751

§ 371 Date: Sep. 26, 2025

(30) Foreign Application Priority Data
Mar. 28, 2023 (DE) 10 2023 107 899.2

(51) Int. Cl. H04M 3/51; G10L 25/63; G10L 25/90; H04M 3/22; H04M 3/42

(52) U.S. Cl. CPC H04M 3/5175; H04M 3/22; H04M 3/42221; G10L 25/63; G10L 25/90

(57) ABSTRACT

A method for communication of a telephone service provider in a communication network including a data network and a telephone network. A recording being carried out by a recording device; an analysis of generated audio recordings with respect to a conversation parameter; a process of ascertaining time-based data connection parameter values in response to the conversation parameter; a simultaneous analysis of the telephone calls, which are transmitted to the telephone service provider via telephone connections, between employees and respective subscriber with respect to the conversation parameter; and a process of ascertaining time-based telephone connection parameter values in response to the conversation parameter and on the basis of a comparison of the time-based telephone connection parameter values with the time-based data connection parameter values.

The present invention relates to a method for communication of a telephone service provider with a first employee and a plurality of another employees of a company in a communication network comprising a data network and a telephone network, as well as a data processing unit, a computer program product and a computer-readable data carrier therefor.

Nowadays, information is often transmitted from companies to customers (users, consumers) by telephone, for example as part of advertising calls or service calls. The term “company” comprises private and state-owned companies, service providers, authorities or similar institutions.

The aim here is for a telephone service provider to provide telecommunication functionalities for audio and video calls between a company and a user, which a company's local telephone system does not offer or only offers to a limited extent. For example, telephone calls should be partially or completely recorded by the telephone service provider, wherein in particular channel-separated stereo recording should be made possible, which causes advantages for the quality control of the calls, or an interruption of recordings for particularly sensitive call sections should be possible. Another example of these telecommunication functionalities are special conference calls or forwarding to other services such as authentication procedures.

For example, advertising contact recordings with a user require the user's explicit prior consent. This declaration of consent is also referred to as an opt-in and relates to the transmission of advertising and information via a specific communication channel, for example via email, telephone or text message. These declarations of consent for contact via certain channels are often obtained by telephone. An audio recording is made of the telephone conversation between an employee of the advertising company and the user. This telecommunication functionality is implemented by a telephone service provider.

For this purpose, the telephone service provider must be able to assign the existing telephone connections between company employees and users via the telephone network to a data connection that exists between the employee and the telephone service provider. The employees communicate with the telephone service provider via the respective data processing unit at the workplace and the data network.

The technical infrastructure of the telephone service provider allows the establishment of a telephone connection between a user and a company or, conversely, the forwarding of a call from an employee to a user. However, the technical infrastructure of the telephone service provider does not show which of the company's employees is making a particular call if no complex CTI integration with the company's telephone system has been carried out. This is due to the fact that although a call is received by a company via the telephone lines from the telephone network, the internal assignment of a telephone call to a specific employee or their telephone is carried out by the company's telephone system, from which no information is usually transmitted to the telephone service provider. Even in the reverse case, when calls from a company employee are routed via the internal telephone system to the telephone lines of the telephone network, the telephone system does not transmit any details to the telephone service provider about the internal assignment to a specific telephone or the acting employee.

Even when an employee of a company is working from home, the connection with a user via the telephone network at the telephone service provider (especially if the connection of the home office employee is realized via the company's telephone system) may not be readily associated with an existing connection of the employee's data processing unit (computer) with the telephone service provider.

In this regard, DE 698 39 033 T2 discloses a virtual call center which makes the complete call center functionality of the telephone system of the call center (or company) available to remotely positioned customer service representatives (CSRs) via a data network. A customer service representative logs into the system via a CSR computer. The customer service representative and/or the CSR computer are authenticated. After the customer service representative has logged in via the computer and has been authenticated by the computer, a voice output unit makes a call to a previously known remote telephone number of the customer service representative and asks him/her to enter a telephone password. Once he has logged in via computer and telephone, he is ready to receive and process incoming customer calls. This results in a permanent connection between the CSR and the company's telephone system.

A method for communication between a telephone service provider and a first employee of a company is known from the document DE 10 2012 002 186 A1. In this method, there is a data connection from the data processing unit of the first employee via the data network and a telephone connection from the telephone of the first employee via the telephone network to the telephone service provider. The following steps are also carried out:
(a) requesting individual identification information by means of the data processing unit by the first employee via the data connection previously configured to the telephone service provider,
b) sending the requested individual identification information from the telephone service provider to the data processing unit of the first employee via the data connection,
c) if necessary, now setting up a telephone connection from the telephone of the first employee via the telephone network with the telephone service provider, if such a telephone connection does not yet exist, wherein at the latest after step c) the telephone connection and the data connection with the telephone service provider exist simultaneously,
d) transmitting the individual identification information previously sent by the telephone service provider from the telephone of the first employee back to the telephone service provider via the existing telephone connection, and
e) receipt by the telephone service provider of the identification information sent back via the telephone connection and assignment by the telephone service provider of the telephone connection with the first employee to the data connection with the first employee on the basis of the identification information sent back. Accordingly, the known method uses unique identification information created for the respective telephone/data connection in order to achieve an assignment of telephone connection and data connection. The retransmission of the identification information from the telephone of the first employee to the telephone service provider may be complex, as this transmission should run in the background for a user of a call with the first employee and should not be perceptible in order to avoid irritating the external user. The procedure requires the cooperation of the employee, which is cumbersome and time-consuming for the employee. In addition, communication with the user must be interrupted in order to send the identification information, which means that the telephone calls take a longer time period and are therefore more cost-intensive. At the same time, the identification information should be recognized without confusion and with error tolerance and enable a unique assignment of data and telephone connection.

Accordingly, the object of the present invention is to provide a simpler, reliable method which does not interfere with a conversation with a user and which enables an employee of a company to communicate with a telephone service provider in a communications network in such a way that extended telecommunications functionalities of the telephone service provider may be utilized and controlled by the respective employee in the course of a telephone call. The object is also to create a corresponding data processing unit or computer program product.

The above object is solved by the method with the features of claim 1.

In particular, the above object is solved by a method for communication of a telephone service provider with a first employee and a plurality of another employees of a company in a communication network having a data network and a telephone network, wherein at the same time (parallel in time) a plurality of data connections of the employees via a data processing unit assigned to the respective employee and the data network in each case to the telephone service provider and a plurality of telephone connections of the employees with users via the telephone network and the telephone service provider exist, wherein the first employee holds a telephone call with a first user via a first telephone connection. The method comprises the following steps:
a) creating an audio recording of the first employee and/or the first user during the telephone call by a recording device connected to the data processing unit assigned to the first employee,
b) analyzing the created audio recording of the first employee and/or the first user with regard to at least one call parameter and determining time-dependent data connection parameter values for the at least one call parameter with regard to the first employee and/or the first user,
c) simultaneous analyzing of the telephone call of the first employee with the first user transmitted via the telephone connection to the telephone service provider with regard to the at least one call parameter and determining time-dependent telephone connection parameter values for the at least one call parameter with regard to the first employee and/or the first user,
d) simultaneous performing steps a) and b) for further data connections of another employees without assignment and/or step c) for further telephone connections of another employees with another user without assignment, so that time-dependent data connection parameter values relating to the at least one call parameter in each case exist for the plurality of these data connections and/or time-dependent telephone connection parameter values relating to the at least one call parameter in each case exist in respect of the respective employees and/or users for the plurality of these telephone connections,
e) comparing the determined time-dependent telephone connection parameter values for the at least one call parameter of the telephone connection of the first employee and, if applicable, the plurality of another telephone connections with the determined time-dependent data connection parameter values for the at least one call parameter of the telephone call of the first employee (i.e. the data connection of the first employee) and, if applicable, the plurality of another data connections,
f) assigning the telephone connection of the first employee and, if applicable, the telephone connections of another employees in each case to a data connection based on the result of the comparisons specified in step e).

Here, the above method by the term telephone network includes at least the analog telephone network, the digital telephone network (e.g. ISDN), the radio network (e.g. GSM) and the packet-transmitting data network (e.g. VoIP) and the like. With regard to a data connection via the data network, the present invention includes all connections comprising the transmission of digital data from one data processing unit (e.g. computer) to another data processing unit. Such a data connection is established, for example, via the Internet. The two connections (telephone connection and data connection) may be established by the employee from a single device, such as a smart phone.

A data processing unit is also used at the telephone service provider, which receives the audio recording transmitted by the employee via the data connection and/or the time-dependent data connection parameter values determined from the audio recording for the at least one call parameter relating to the employee and/or the users. In addition, this data processing unit at the telephone service provider also receives and/or processes the telephone call of the employee with the respective user transmitted via the respective telephone connection with respect to the at least one call parameter relating to the employee and/or the user. A corresponding telephony hardware and/or telephony software provided in each case in the data processing unit of the telephone service provider may be used for this purpose.

According to the invention, the telephone connection from an employee of a company to the telephone service provider may in particular form a section of the employee's connection with an (external) user. In this case, the telephone connection includes the connection between the user and the employee of the company via the telephone service provider. In particular, the telephone call may be transferred to another employee of this or another company by means of a transfer. In the latter case, the method steps according to the invention must be carried out again with regard to the employee who continues the telephone call, so that a correct assignment of the data connection of this employee to the telephone connection with the telephone service provider is realized. In another embodiment, the employee may be outside the company, e.g. in the home office. In this case, the telephone connection is usually also made via the company's telephone system and the method according to the invention described above may be implemented analogously for such an employee.

If necessary, the telephone connection to another employee of the company or to an (external) user is made via other telephone service providers. The telephone connection from the active employee of the company to the (first) telephone service provider may also be made via another telephone service provider.

In the method according to the invention, a large number of data connections between the employees of a company (e.g. call center) and the telephone service provider via the data network exist concurrently. The employees include the first employee, who has been singled out as an example in order to explain the method. Furthermore, there is already a telephone connection from the telephone of the first employee via the telephone network to the telephone service provider, wherein the first employee holds a telephone call (conversation) with the first user via this telephone connection. There may also be other telephone connections between another employees and another users. Furthermore, a recording device, i.e. a microphone or the like, connected to the data processing unit at the employee exists, which may record the telephone call of the employee with the user and thus generate an audio recording. The audio recording may be generated via a microphone in the data processing unit for both the channel of the employee and the channel of the user, or for a common channel. The audio data may be generated by the microphone separately, for example, or, for example, when the employee uses a headset in the telephone call, it may be picked off from a driver in the operating system software.

In step a) of the method, an audio recording of the first employee and/or the first user is generated by a recording device during the telephone call. In step b), time-dependent data connection parameter values are determined from this audio recording(s) and then transmitted to the telephone service provider (or its data processing unit, respectively) via the data connection. Therefore, this audio recording and the time-dependent data connection parameter values obtained from this recording, respectively, is characteristic for the data connection existing to the first employee. The telephone call is recorded at least sectionwise, for example a stream of the telephone call of a predetermined length, where appropriate buffered, is recorded and corresponding audio data is generated. The audio recording may only contain the channel of the first employee and/or the channel of the first user or the shared channel. The audio recordings of the corresponding channels obtained may then be digitized in one embodiment, for example at a sampling rate of 8 kHz or 22 kHz or 44 kHz and using the WKS sampling theorem, so that digital data of the audio recordings is available for the respective channels. This data is subsequently analyzed in more detail with regard to at least one call parameter, as shown in more detail below. For each call parameter and for each channel, time-dependent data connection parameter values (i.e. the time course of data connection parameter values over the selected section, wherein the section may also comprise the entire telephone call of the employee) are determined on the basis of the (if applicable digitized) audio recording. This is explained below by means of an example and is carried out, for example, analogously for other call parameters.

In the example, the audio recording of the relevant channel is divided into equidistant time sections (also known as buffer sections) for the analysis with regard to specified call parameters. A buffer section is a section with respect to time of the digitized audio data that is evaluated with regard to the respective call parameter as a unit/entirety. This has the advantage of reducing the amount of data for comparison.

Accordingly, in one embodiment, the audio data of each channel that was generated in a time-dependent manner is divided into buffer sections for the analysis. A buffer section may, for example, represent a section of 10 ms, 50 ms, 100 ms, 150 ms or 200 ms. When analyzing the audio recording, in one embodiment, sections of 50 ms may be analyzed accordingly with regard to a call parameter. For example, an average volume level may be determined for all level values of the audio recording in the respective buffer section. This average volume level (determined as an arithmetic mean) is the data connection parameter value for this buffer section and for the call parameter “average level value”. The time course of the data connection parameter values is determined by temporally correct sequencing of the data connection parameter values of each buffer section. The result is a sequence of data connection parameter values (1 value for each buffer section and for each call parameter) for each channel and for each call parameter, timely one after the other. In other words, there are single-column matrices of data connection parameter values for each buffer section and each channel, wherein each row of this matrix contains the recording parameter value for a call parameter and the respective buffer section.

The buffer sections may have different lengths for different call parameters, e.g. 50 ms for one call parameter and 200 ms for another call parameter.

Accordingly, the result of this analyzing step for the first employee and/or first user is a representation of time-dependent data connection parameter values for each call parameter and each channel, wherein it has been previously determined whether the employee channel and/or the user channel or a common channel is determined from the audio recording. Thus, for the embodiment described above, the result for each channel consists in a single-column matrix of data connection parameter values for each buffer section over a predetermined recording period. Each matrix contains a single value (the recording parameter value) for each call parameter. The buffer section may comprise a specific length for the respective call parameter—i.e. different specific lengths for different call parameters.

The steps described above of creating the audio recording and analyzing the created audio recording may be carried out simultaneously for further telephone calls of another employee with another user for data connections that have not yet been assigned to a telephone connection, i.e. without assignment. Each of the other employees or their data processing unit has a recording device for this purpose, which may be connected to the respective data processing unit. The result of the analysis thus consists of corresponding time-dependent data connection parameter values for each data connection that has not yet been assigned to a telephone connection, including that of the first employee.

Simultaneously to the above steps, the telephone call of the first employee with the first user transmitted via the telephone connection to the telephone service provider is analyzed with regard to the same call parameters analogous to the analysis of the audio recording described above. Accordingly, a time course of telephone connection parameter values (i.e. determined time-dependent parameter values via the telephone connection) is determined here for the at least one call parameter in relation to the first employee and/or the first user (i.e. again in relation to the employee channel and/or the user channel or a common channel). It is important here that the same call parameters and the same channels are examined that are also used to determine the data connection parameter values. For the above embodiment, a one-column matrix of telephone connection parameter values is formed analogously for each corresponding channel or both channels and each buffer section of a given recording time period. The matrix contains a single value (the telephone connection parameter value) for each call parameter. Accordingly, for another telephone calls of another employees for which no assignment to a data connection exists yet, the respective telephone calls may be analyzed analogously with regard to the at least one call parameter, so that the result is a plurality of time-dependent telephone connection parameter values for the at least one call parameter.

The analysis of the audio recordings of the first employee and/or another employees or the analysis of the telephone call via the telephone connection may be performed by the data processing unit belonging to the respective employee. Alternatively, the audio recordings of the telephone calls created by the recording device may be forwarded to the telephone service provider, which performs the analysis using the data processing unit available at the telephone service provider. As another alternative, the analysis may be performed using cloud computing. If the analysis is performed using the employee data processing unit or using cloud computing, then the corresponding results are subsequently forwarded to the telephone service provider's data processing unit.

In an embodiment, the above steps (analyzing the telephone call via the data connection and the telephone connection and a plurality of audio data transmitted via parallel data and/or telephone connections) are performed simultaneously and continuously during a predetermined analysis time period from the start of a telephone call. The data processing unit of the telephone service provider recognizes that a telephone call has begun. In one embodiment, the telephone service provider has a data queue with a predetermined data volume (the length of the queue) for each telephone connection and each data connection, in which the oldest data is dropped when the predetermined data volume is exceeded. Each queue contains the data connection parameter values or the telephone connection parameter values of the at least one call parameter in the chronological order in which they are determined on the basis of the telephone call, i.e. they correspond to the chronological development of the telephone call.

In the step subsequently following the analysis, as explained above in step e), the determined data connection parameter values and the determined telephone connection parameter values for the respective channel or both channels are compared with each other, which is carried out by means of the data processing unit of the telephone service provider. In each case, the data connection parameter values and the telephone connection parameter values of the first employee are contained in the comparison data. In order to obtain a comparison over time, this comparison is carried out over a predetermined time period for predetermined time intervals (in the example: buffer sections). The parameter values for the same call parameter are compared with each other, wherein a comparison is made for each call parameter if there are several call parameters. The comparison is also carried out on the basis of a chronological assignment, i.e. in relation to the telephone call, it is necessary that the parameter values are compared with each other which correspond to each other in relation to a time interval of the telephone call, i.e. which can be assigned to the same time in the telephone call (i.e. which comprise the same position in the queue in relation to the queue described above, for example). Further, a comparison of the temporal development of the telephone connection parameter values with the temporal developments of the data connection parameter values is performed for each data connection that has not yet been assigned to a telephone connection, including that of the first employee. Referring to the above embodiment, the parameter values of the single-column matrices are compared with each other for each buffer section on a channel-by-channel basis. During the comparison, for example, the value by which the parameter values deviate from each other is determined (i.e. the difference amount is calculated) and this deviation is compared with a predetermined threshold value. In one embodiment, a separate call parameter threshold value is assigned for each call parameter. Alternatively, a single threshold value may be used for all or at least a proportion of the call parameters. If a deviation smaller than the predetermined threshold value is determined for at least a predetermined proportion of the call parameters, it is determined that the parameter values, i.e. the data connection parameter values and the telephone connection parameter values, are similar.

Based on the above comparison, the telephone connection of the first employee may then be automatically assigned to that of the existing data connections if the comparison for that data connection and the telephone connection reveals that the parameter values are similar over a predetermined time period, for example 1 s to 10 s. Therefore, the comparison of the time history involves capturing the change in the parameter values over the course of the telephone call. In the example, the data connection with the first employee is assigned to the telephone connection of the first employee with the first user. It should be explicitly indicated at this point that before the method according to the invention was carried out in the communication network, it was not known that the telephone connection of the first employee to the first user belonged to the data connection of the first employee. The same applies analogously to other telephone and data connections of another employees that have not yet been assigned.

The advantage of the method according to the invention is in particular that no (separate) identification information needs to be exchanged between the telephone service provider and the employee in the method. The assignment of the data connection to the telephone connection (or vice versa) with the recording step, the analysis steps and the comparison step on which the assignment is based is carried out automatically simultaneously with the telephone call without disturbing the employee's communication with the user. The assignment of telephone connection and data connection thus takes place in the background, so to speak, while the employee is on the phone with the user. It is also very reliable and fast as well as cost-effective, as the employee does not have to interrupt his or her verbal conversation with the user for the assignment and the call may therefore be carried out more quickly. An interruption would prolong the call and would therefore be more cost-intensive. It may also be adapted to the conditions in the area of the user and the participant. For example, the operation of the recording device may be adapted for the respective employee (e.g. via level adjustment, additional amplification, filters) or the threshold values may be adapted based on automatic analyses.

The assignment of an existing data connection to an existing telephone connection achieved with the method according to the invention thus enables the employee to control his telephone call in relation to telecommunications functionalities of the telephone service provider with the user via the (first) telephone service provider by means of the data connection. For example, the employee of the company may activate or deactivate recording functionalities of the telephone service provider for recording telephone calls or telephone call segments at the click of a mouse. In other words, the first employee of the company may trigger the functionality offered by the telephone service provider to record the audio of the telephone call via the data connection with the telephone service provider. Similarly, other CTI functionalities such as establishing telephone connections with another user, forwarding the telephone call to second employees or a conference call in the telecommunication functionalities of the telephone service provider may be initiated by the first employee of the company. The telephone service provider may also send feedback to the first employee via the data connection about the functionality triggered by the employee. Such feedback may concern the quality of audio recordings, the status of a call transfer or similar. Other telecommunication functionalities may include translation and speech recognition functionalities, noise suppression, emotion detection or another functionality relevant for a telephone call or for a section of a telephone call.

The present method according to the invention is also suitable for the still existing case in which the telephone connection runs at least partially over the analog telephone network. In this case in particular, it is often not possible to clearly assign the employee's telephone to the telephone service provider using the conventional method. Telephoning via the analog telephone network has not completely disappeared even in the age of mobile communication. Therefore, the method according to the invention provides telephone service providers with a new opportunity to provide modern telephony functions for telephoning via the “fixed network” as well.

In one embodiment, the at least one call parameter comprises, for example, predetermined words, speech rhythm, volume level, pitch, a dominant frequency and/or emotions. For example, the parameter “predetermined words” is a predetermined frequency pattern in a predetermined time period, the parameter “speech rhythm” is a moving average of the pauses and/or the word lengths of the telephone call in seconds over a predetermined time period, which may extend over several buffer lengths, for the “volume level” parameter, the mean value of the absolute decibel amounts as a percentage of the maximum decibel amount over a specified time period, for the ‘pitch’ parameter, the mean or maximum frequency over a specified time period, for the “dominant frequency”, the most frequently used frequency over a specified time period, for the “emotions” parameter, the mel frequency cepstrum coefficient (MFCC) over a specified time period of the telephone call. The predetermined time period may, for example, represent the length of a buffer section or multiple buffer sections. In another embodiment, it may be analyzed whether the volume level in a buffer section is below a predetermined minimum level value or above a maximum level value, or an average value (e.g. the arithmetic mean) of all volume levels of the buffer section or a maximum value of all volume levels of the buffer section or a weighted maximum value of all volume levels of the buffer section (mean value (e.g. the arithmetic mean) of the 10% or 25% or 50% largest volume level values of the buffer section) is determined for the buffer section. Alternatively or additionally, a dominant frequency may be determined by performing a Fast Fourier Transform (FFT) of the volume level values and determining the frequency of the buffer section comprising the highest or smallest or second highest or second smallest absolute value. The specified call parameters are considered to be well suited to achieve a fast and reliable assignment of the data connection to the telephone connection.

When analyzing whether the volume level in a buffer section is below a predetermined minimum level value, as in the embodiment described above, the timing and length of pauses (or silences) between the spoken (or otherwise articulated sounds) is determined. The buffer section in which the volume level is below the minimum level value is considered a pause (silence). The length of the pause corresponds to the number of consecutive buffer sections in which the volume level is below the specified minimum level value. This is an easily determinable and meaningful call parameter. However, this special call parameter should not be used as the only call parameter for assigning a data connection to a telephone connection. The reliability of the assignment is raised by using another (different) call parameters to compare the telephone connection parameter values with the data connection parameter values when using the call parameter that describes the time position and length of the pauses.

In an embodiment described above, the advantageous procedure was described in which the comparison of the temporal courses of the telephone connection parameter values and the data connection parameter values is carried out separately for the employee and the user. A distinction is made between the employee's channel and the user's channel. One of these channels or both channels may be used to compare the telephone connection parameter values with the data connection parameter values. For example, stereo recording may be used to determine the channels of the employee and the user separately and therefore they may be distinguished.

In one embodiment, the time-dependent telephone connection parameter values and the time-dependent data connection parameter values are compared at least twice by the telephone service provider, wherein in the second comparison the telephone connection parameter values and the data connection parameter values are offset in time by a predetermined time interval with respect to the first comparison, i.e. comprise an offset. This takes into account the fact that the temporal course of the data connection parameter values and the telephone connection parameter values is often shifted. This offset may, for example, be caused by the calculation of the values and the runtime of the data in the networks or by the time required to create the audio recording using the recording device. For example, the predetermined time interval may represent the length (PL) of one or more buffer sections (offset=N×PL, wherein N=1, 2, 3, . . . ). For example, if the length of a single buffer section (PL) is 50 ms, the time offset (i.e. the predetermined time interval) used in the second comparison may be 50 ms, 100 ms, 150 ms, 200 ms, and so on. The predetermined time interval may, for example, be less than or equal to 500 ms. For the embodiment, this means that the comparison is not only carried out with respect to temporally identical recording and telephone connection parameter values with respect to temporally identical buffer sections, but also for each data connection with respect to recording and telephone connection parameter values that are shifted forward and backward in time by N buffer sections (N=1, 2, 3, . . . ). In one embodiment, if an assignment of a telephone connection to a specific data connection with the same offset could be determined over a predetermined time interval (e.g. the length of at least 3 buffer sections), the corresponding offset is taken as the starting point for another determination of the assignment. In order to speed up the procedure, the system then no longer checks whether an assignment exists for all the specified offset variants, but only for the same time offset for which the parameter values were previously determined to match. So if, to return to the example, it was previously determined that a particular data connection can be assigned to the telephone connection at an offset of 150 ms over 3 buffer sections in succession, then the comparison of the parameter values is then only carried out for the offset of 150 ms in the same direction for the following buffer sections. In another embodiment, the offset is used as an additional criterion for assigning a data connection to the telephone connection. Only if the offset of the similar parameter values is the same is it concluded that the respective data connection can be assigned to the telephone connection.

In one embodiment, the respective duration of a constant data connection parameter value and telephone connection parameter value over the temporal course of the telephone call is also included in the comparison according to step e). For this purpose, it is determined when the time-dependent parameter value changes and for that point in time it is determined over which time interval (e.g. over how many buffer sections) the respective parameter value was constant until then. This may, for example, be expressed in the number of buffer sections PL. During the comparison, both the parameter values and the time intervals may then be compared with each other (or subtracted from each other and the difference compared with a corresponding threshold value). This has the advantage that a comparison of time-dependent parameter values leads to good results even if the offset does not correspond exactly to a multiple of the length of a buffer section. Furthermore, this embodiment of the comparison saves time and resources, as it is not necessary to analyze different offset variants. In addition, only the respective parameter values, which may be constant over several buffer sections, are compared with each other, which is also less time-consuming compared to the individual comparison for each buffer section. Furthermore, the offset may be determined by the distance between the points in time at which a synchronized change in the parameter values occurs with regard to the respective telephone and data connection and, if necessary, used for a further analysis of the parameter values.

In one embodiment, the comparison of the determined time-dependent telephone connection parameter values for the at least one call parameter of the telephone connections with the determined time-dependent data connection parameter values for the at least one call parameter of the data connections may be carried out using artificial intelligence methods (AI methods). For example, methods that work with neural networks may be used for this purpose, as these are particularly suitable for pattern recognition.

In one embodiment, the call parameters are analyzed by processing the call data in such a way that it is impossible to draw conclusions about the content of the call. This may be done by determining the parameter values for the call parameters via buffer sections that are sequenced in time, e.g. 50 ms buffer sections, as described above. In the context of the example given, which uses temporal subdivision into buffer sections, the data connection parameter values are determined in the employee's data processing unit, for example, and only the determined data connection parameter values are sent to the telephone service provider. From the data connection parameter values, the call content may not be inferred.

In one embodiment, the comparison is made over a minimum period of time and/or a predetermined number of call parameters is used for the comparison and/or call parameter-individual matching criteria between the temporal courses of the data connection parameter values and the telephone connection parameter values are taken into account. The comparison of the data connection parameter values with the telephone connection parameter values for the call parameters is carried out over a minimum period of the telephone call in order to obtain the greatest possible certainty. This means that the assignment of the data connection to the telephone connection must be present for at least the specified minimum period (e.g. 20 buffer sections of 50 ms each=1 s to 200 buffer sections or 1 s to 10 s) in order to reliably assume that this telephone connection actually belongs to this data connection. Sufficient certainty of the assignment is also achieved if the similarity of the parameter values is determined for a predetermined number of call parameters (e.g. 10 absolute or relative to the processed call parameters at least 80%) of all call parameters. Furthermore, call parameter-individual matching criteria between the temporal courses of the data connection parameter values and the telephone connection parameter values may be taken into account. This includes the criteria, e.g. the threshold value in the assessment of the difference amount (amount of deviation of the telephone connection parameter value from the data connection parameter value for a call parameter, a channel and a buffer section), which is used to decide whether the respective parameter values deviate greatly or to a tolerable extent from each other and therefore speak against or in favor of an assignment of the telephone connection to the respective data connection. These matching criteria may—depending on the call parameter—be different and may, for example, be a threshold value of 95% match for the call parameter average volume and/or a threshold value of 90% match between the telephone connection parameter value and the data connection parameter value for the call parameter dominant frequency. With respect to the call parameter pause/silence, wherein the call parameter value may be either 1 (pause/silence) or 0 (no pause/silence), no such threshold is applied.

In one embodiment, for security reasons, if none of the plurality of data connections to the telephone service provider is assignable to the telephone connection of the first employee, the telephone connection to the first employee will be disconnected. Alternatively, other assignment methods may be used.

In a first embodiment, the determination of the time-dependent telephone connection parameter values and the time-dependent data connection parameter values and the above-described comparison of these parameter values is terminated after the telephone connection has been assigned to the data connection on the basis of the comparison for the respectively assigned telephone connection and the respectively assigned data connection. In another embodiment, after the assignment of a telephone connection of an employee to a data connection, the above-described procedure may also be continued for already assigned telephone connections and already assigned data connections permanently or at predetermined time intervals with the above-described determination of the time-dependent telephone connection parameter values and the time-dependent data connection parameter values and the above-described comparison of these parameter values in order to detect incorrect assignments.

In one embodiment, after a telephone connection of a first employee has been assigned to a data connection, the telephone service provider may, after a corresponding request by the first employee, establish a second telephone connection with at least one second user via the data connection and switch the telephone connection of the first employee to the first user via the telephone service provider to the second user or forward it to the second user. The switching of the telephone connection is to be understood in such a way that before switching, the first user is connected to the first employee of the company via the telephone service provider. After switching, the second user is connected by telephone to the first employee via the telephone service provider. The assignment of the first employee's data connection and telephone connection with the telephone service provider does not need to be renewed after switching.

When a telephone call is forwarded, the telephone service provider establishes a second telephone connection with at least one second employee of the first company or of a second company on the basis of appropriate control by the first employee of the company, to which the first telephone connection of the first user with the telephone service provider may be transferred (switched), also controlled by the first employee. This is to be understood in such a way that the telephone call of the first user with the first employee is switched or forwarded via the telephone service provider to a telephone connection of this user with the second employee, in each case via the telephone service provider. If the second employee is also to make use of the telecommunications functionalities of the telephone service provider, the second telephone connection must again be correctly assigned to a data connection between the telephone service provider and the second employee using the assignment procedure according to the invention. In this way, for example, a telephone call with a user may first be answered by an employee of a company and then transmitted to an employee of an external call center to complete the call. This is advantageous because the employee of the company who was first on the call is available again for the company's core business as soon as the call has been transferred to a call center.

It is also advantageous if the first user and/or the second user have a data connection to the telephone service provider, as it is then also possible for the respective user to control the telecommunications functionalities of the telephone service provider via the respective data connection. In this way, the functionalities of the telephone service provider may also be used by the first user and/or the second user.

In another embodiment, at least a proportion of a telephone call of the first user and/or the second user with the first employee or the second employee transmitted via the telephone connection is recorded and preferably associated with the data connection with the respective employee or respectively with at least one data information transmitted via this data connection. Such data information includes, for example, a start or stop signal for the start and end of the call recording, personal data or a customer or contract number of the user talking to the employee. This makes it easy for the telephone service provider to record telephone calls or sections of telephone calls, for example as part of an opt-in procedure, assign various data such as the name and address of the user and, if necessary, store them together with this additional data information for verification purposes. Due to the possibility of assigning data information to the call recordings, this call information, such as opt-ins, may be managed by the telephone service provider. Management may also take place in such a way that the status of the users' opt-ins is checked at regular intervals and whether opt-ins are missing or have expired. Missing or expired opt-ins may be reported to the responsible employee of a company so that they can complete or renew them. In the event of a complaint, previous call recordings of telephone calls with the respective user may be imported into the current call via the telephone service provider at the request of the company employee connected to the user.

The above object is also solved, with the advantages explained above with regard to the method, by a data processing unit having the features of claim 11, a computer program product having the features of claim 12 and a computer-readable data carrier having the features of claim 13.

In particular, the object is solved by a data processing unit for use by a telephone service provider for communicating with a first employee and a plurality of another employees of a company in a communication network having a data network and a telephone network, wherein simultaneously a plurality of data connections of the employees, including the first employee, are established via the data network in each case to the telephone service provider and a telephone connection from the telephone of the first employee and, if applicable, of a plurality of another employees of the company via the telephone network to the telephone service provider can be established, wherein a telephone call can be made by the first employee via the telephone connection to a first user and a telephone call can be made by the another employee via the telephone connection to another user, wherein the data processing unit is configured to carry out the method described above. The data processing unit has the advantages described above with regard to the method.

In addition, the object is solved by a computer program product for communication of a telephone service provider with a first employee and a plurality of another employees of a company in a communication network with a data network and a telephone network, which comprises instructions which, when executed by one processor or a plurality of processors, cause the respective processor to perform the steps of the method described above. The processors may be arranged locally at different locations in the data network, but are connected to each other via a data connection. The computer program product also comprises the advantages stated above.

Accordingly, the computer program product is configured to communication of a telephone service provider with a first employee and a plurality of another employees of a company in a communication network with a data network and a telephone network with program code means for executing a computer program after its implementation in a data processing unit, wherein the program code means are provided to execute the method described above after the implementation in the data processing unit.

The object is solved in particular by a computer-readable data carrier which stores a computer program product as described above.

Other features, advantages and possible applications of the invention are also apparent from the following description of an embodiment and the figures. All the features described and/or illustrated form the subject of the present invention, either individually or in any combination, even independently of their summary in the claims or their references.

It is shown schematically:

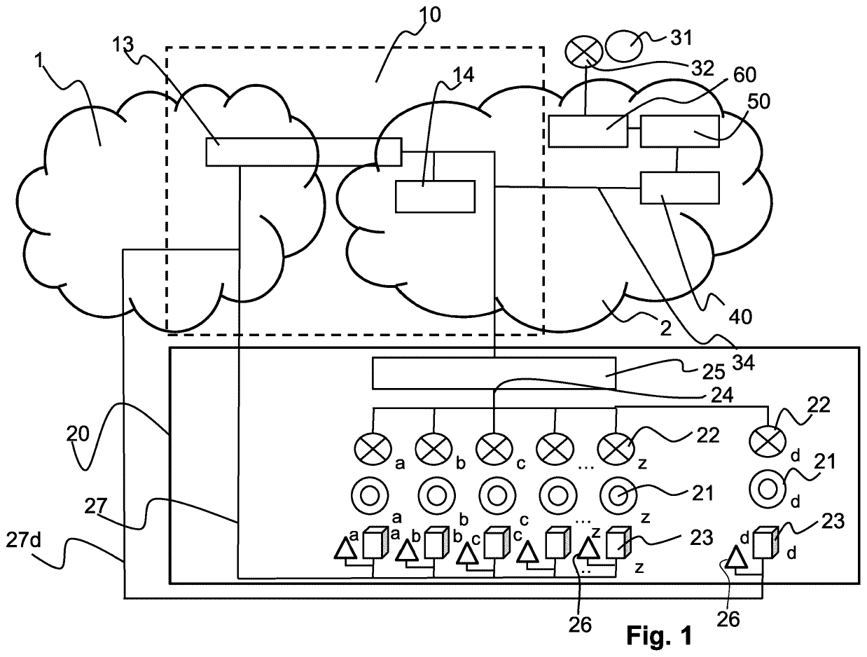

FIG. 1 shows a communication network in which the method according to the invention takes place,

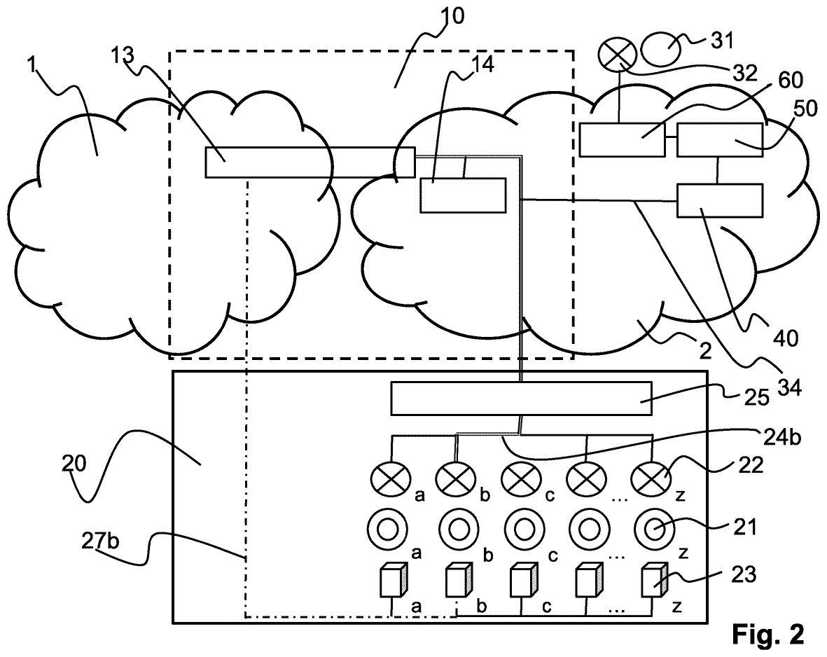

FIG. 2 illustrates the communication network shown in FIG. 1 with a specific data and telephone connection,

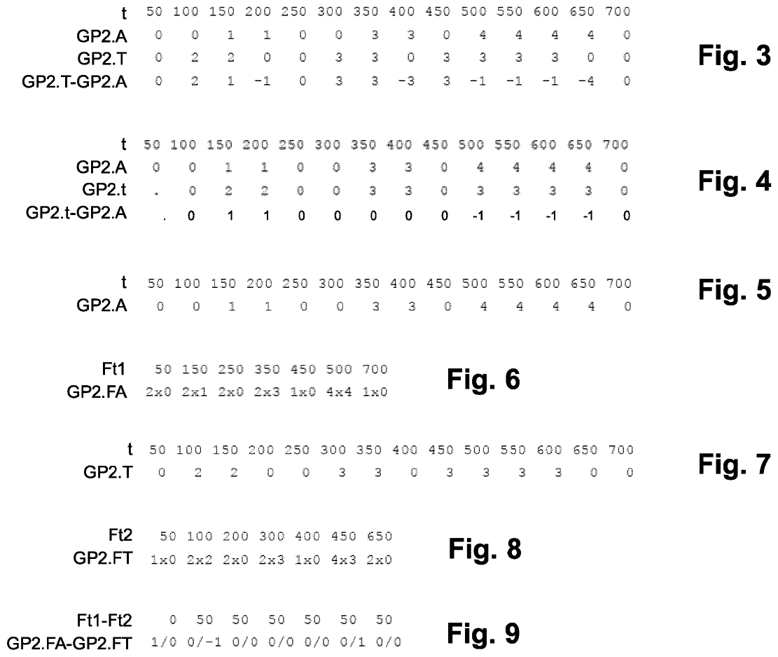

FIGS. 3 and 4 illustrate a first embodiment for the comparison of the determined time-dependent telephone connection parameter values for the telephone call of a first employee with a user and the determined time-dependent data connection parameter values for a data connection with respect to a single call parameter, and

FIGS. 5 to 9 a second embodiment for the comparison of the determined time-dependent telephone connection parameter values for the telephone call of a first employee with a user and the determined time-dependent data connection parameter values for a data connection with respect to a single call parameter.

FIG. 1 shows a data network 1 and a telephone network 2, which together form the communication network. Thereby, the data network 1 is preferably the Internet, while the telephone network 2 includes in particular the analog telephone network, the digital telephone network as well as the radio network and VoIP.

A company, service company, call center or the like, hereinafter referred to as company 20 for short, is connected to the communication network, where a number of employees 21 (employee a, employee b, employee c, employee d, . . . , employee z) work. Each employee 21 has a telephone 22 (telephone a, telephone b, telephone c, telephone d, . . . , telephone z) and a data processing unit 23 (computer a, computer b, computer c, computer d, . . . , computer z). The telephone may be integrated into the data processing unit. Each telephone 22 of the employees 21a, b, c, z present locally in the company is connected to the telephone network 2 via a telephone connection 24 and the telephone system 25. Furthermore, each computer 23 is also connected to the data network 1 via a data connection 27. The employees 21 do not necessarily have to be present locally on the company's premises, but may also work mobile (e.g. in the home office). This is indicated in FIG. 1 for employee 21d, who has a telephone 22d and a data processing unit 23d. This employee may also be connected to the telephone network 2 via the telephone system 25, as shown. Furthermore, he or she is also connected to the data network 1 via a data connection 27d.

A plurality of telephone service providers 10, 40, 50 and 60 operate in the communication network 1, 2, which provide a range of telecommunication functionalities in the area of telephony and data processing outside the system of a company 20.

Part of the communication network may also include at least one user 31, which is also connected to the telephone network 2 via a telephone 32 and a telephone connection 34. In addition, the user 31 may also have a data processing unit (not shown) comprising a connection to the data network 1. A telephone system may also be connected between the telephone 32 of the user 31 and the telephone network 2.

If a call is now to be made to the user 31 by an employee 21 of the company 20, the employee 21 (for example employee b) may first establish a data connection 27b via the data processing unit 23 (for example computer b) to the data processing unit 13, in particular to the data processing unit of the telephone service provider 10 equipped with the method according to the invention and contained therein. This data processing unit 13 of the telephone service provider 10 is, for example, a web server with web applications; however, it may also comprise a (possibly cloud-based) computer system consisting of a plurality of servers and applications. Furthermore, the employee 21 (for example, employee b) begins a telephone call via the telephone system 25 to the user 31 via the data processing unit 13 of the telephone service provider 10 having telephony hardware and software. Accordingly, a telephone connection 24b is established with the telephone service provider and a telephone connection 34 is established to the user 31. Before the start of the method according to the invention, the data processing unit 13 of the telephone service provider has no knowledge that the data connection 27b of the employee 21b belongs to the telephone connection 24b. In other words, this assignment is not known.

In FIG. 2, the respective connections of the selected employee 21b with the telephone service provider 10 are marked separately, namely the telephone connection 24b with a double line and the data connection 27b with a dot-dashed line. This is intended to emphasize the respective connections that are to be assigned to each other using the procedure below. In this figure, the employee 21d with his/her data processing unit 23d and telephone 22d and the respective connections to the telephone network 2 and data network 1 are omitted.

In order to enable the telephone service provider 10 to provide its extended telecommunications functionalities for telephone calls and to provide control of these functionalities by the employee (e.g. employee 21b) of the company, it is necessary for the telephone service provider 10 to assign a data connection to a telephone call of an employee (e.g. employee 21b) with a user 31, i.e. to this telephone connection which is made via the telephone service provider, which data connection exists between this employee and the telephone service provider. This applies both to the employees 21a, b, c, z located locally in the company 20 and to the employee 21d working in the home office.

For this purpose, an audio recording is captured by the recording device 26b (e.g. microphone) of the employee 21b during the telephone call with the user 31. The recording device 26b may also be integrated into the data processing unit 26. For the sake of simplicity, it is assumed in the following that only the channel of the employee 21b is used for the analysis and assignment. However, it is also possible to use only the channel of the user 31 or both channels for the analysis and assignment. This is then carried out in the same way as for the employee channel.

The audio recording/audio signal of the employee 21b is captured by means of the recording device 26b and digitized by the employee's computer 23b using a known sampling method (at, for example, 8 kHz). Thereafter or during recording and/or digitization, the captured portions of the conversation are divided into buffer sections of 50 ms. For each section A1, A2, A3, the data connection parameter values of the call parameters are determined. For example, the following call parameters are examined:
GP1: Silence (are all volume level values of the respective buffer section less than a specified minimum level value? Yes=1, No=0),
GP2: the average volume of the buffer section (the arithmetic mean of the volume level values over the entire buffer section is determined),
GP3: according to FFT-frequency with the highest absolute value (an FFT (Fast Fourier Transformation) analysis of all volume level values of the buffer is carried out and the frequency comprising the highest absolute value is determined from the identified frequency components).

As a result (i.e. the time course of the data connection parameter values), a single-column matrix with three rows is obtained for each buffer section, wherein each row contains the data connection parameter value for this buffer section, for example,

$$[ \begin{matrix}GP 1. A 1 \\ GP 2. A 1 \\ GP 3. A 1\end{matrix} ]$$

for the first buffer section,

$$[ \begin{matrix}GP 1. A 2 \\ GP 2. A 2 \\ GP 3. A 2\end{matrix} ]$$

for the second buffer section,

$$[ \begin{matrix}GP 1. A 3 \\ GP 2. A 3 \\ GP 3. A 3\end{matrix} ]$$

for the third buffer section,

$$[ \begin{matrix}GP 1. A 4 \\ GP 2. A 4 \\ GP 3. A 4\end{matrix} ]$$

for the fourth buffer section, etc. The single-column matrices with the data connection parameter values for the one data connection are then forwarded to the telephone service provider 10 for comparison with the telephone connection parameter values. The recording of the telephone call, the digitization, the subdivision into the buffer sections and the analysis of each buffer section with regard to the call parameters GP1, GP2 and GP3 as well as the forwarding of the determined data connection parameter values for the call parameters is also carried out by the respective computers 23 of all existing data connections which are not yet assigned to a telephone connection. Consequently, at the data processing unit 13 of the telephone service provider 10, the data connection parameter values for a plurality of data connections are known for at least a predetermined time period.

At the same time, the data processing unit 13 of the telephone service provider 10 analogously divides the channel of the employee of the already digitized telephone call received by the telephone service provider 10 via the telephone connection 24 (procedure as for the audio recordings) into buffer sections T1, T2, T3 of a length of 50 ms and analyzes each buffer section with regard to the same call parameters GP1, GP2 and GP3. Accordingly, the result for each buffer section is a single-column matrix with three rows (corresponding to the temporal course of the telephone connection parameter values), wherein each row contains the telephone connection parameter value for this buffer section, for example,

$$[ \begin{matrix}GP 1. T 1 \\ GP 2. T 1 \\ GP 3. T 1\end{matrix} ]$$

for the first buffer section,

$$[ \begin{matrix}GP 1. T 2 \\ GP 2. T 2 \\ GP 3. T 2\end{matrix} ]$$

for the second buffer section,

$$[ \begin{matrix}GP 1. T 3 \\ GP 2. T 3 \\ GP 3. T 3\end{matrix} ]$$

for the third buffer section,

$$[ \begin{matrix}GP 1. T 4 \\ GP 2. T 4 \\ GP 3. T 4\end{matrix} ]$$

for the fourth buffer section, etc.

The determined telephone connection parameter values are subsequently compared by the data processing unit 13 of the telephone service provider 10 with the determined data connection parameter values of the plurality of data connections for the same time period. A possible offset is taken into account here. For the sake of simplicity, it is assumed that the offset in the present example is ±50 ms, i.e. the time interval of a buffer section. The offset may be smaller or larger than the offset of ±50 ms and therefore may include significantly more buffer sections.

Taking this offset into account, the following parameter values are now compared with each other:

$$[ \begin{matrix}GP 1. T 2 \\ GP 2. T 2 \\ GP 3. T 2\end{matrix} ]$$

with

$$[ \begin{matrix}GP 1. A 1 \\ GP 2. A 1 \\ GP 3. A 1\end{matrix} ] , [ \begin{matrix}GP 1. A 2 \\ GP 2. A 2 \\ GP 3. A 2\end{matrix} ] and [ \begin{matrix}GP 1. A 3 \\ GP 2. A 3 \\ GP 3. A 3\end{matrix} ] ,$$

respectively;

$$[ \begin{matrix}GP 1. T 3 \\ GP 2. T 3 \\ GP 3. T 3\end{matrix} ]$$

with

$$[ \begin{matrix}GP 1. A 2 \\ GP 2. A 2 \\ GP 3. A 2\end{matrix} ] , [ \begin{matrix}GP 1. A 3 \\ GP 2. A 3 \\ GP 3. A 3\end{matrix} ] and [ \begin{matrix}GP 1. A 4 \\ GP 2. A 4 \\ GP 3. A 4\end{matrix} ] ,$$

respectively, etc.
wherein corresponding parameter values of the same call parameter GP1, GP2 or GP3 are compared with each other, e.g. GP1.T2 with GP1.A1, GP2. T2 with GP2.A1 and GP3. T2 with GP3.A1. The parameter values are considered similar if the amount of the difference between the parameter values to be compared is below a threshold value GGP1, GGP2, GGP3 specific to the respective call parameter, i.e. they are similar if, for example,

$$\vert GP 1. T 2 - GP 1. A 1 \vert < GGP 1 ,$$

$$\vert GP 2. T 2 - GP 2. A 1 \vert < GGP 2 and$$

$$\vert GP 3. T 2 - GP 3. A 1 \vert < GGP 3.$$

If the parameter values are similar for a predetermined minimum number of consecutive buffer sections with the same offset (offset by +1 buffer section, same buffer section or −1 buffer section) and for a predetermined percentage of the call parameter values, respectively, it is provisionally assumed that the data connection underlying the data connection parameter values is to be assigned to the employee holding the telephone call that is transmitted via the telephone connection and on which the telephone connection parameter values are based. The offset at which the similarity was determined for the specified minimum number of consecutive buffer sections is regarded as the “identified time offset”. For this identified temporal offset (here e.g. −1 buffer section), the similarity of the parameter values is observed further until a predetermined time period, e.g. 3 seconds, is reached over which the similarity of the parameter values exists in total. In this case, the respective data connection can be assigned to the telephone connection. If during the further analysis it turns out that a similarity cannot be achieved over such a predetermined time period, the preliminary assumption that the respective data connection can be assigned to the respective telephone connection is dropped. The comparison of the data connection parameter values with the telephone connection parameter values is then continued for another data connection.

The comparison described above is shown as an example again in FIGS. 3 and 4 for the telephone connection of the first employee and any data connection as well as the call parameter GP2 (average volume of the buffer section). FIG. 3 shows the measured buffer sections (in ms) in the top line t, wherein the last time value of the respective buffer section is always indicated. The first buffer section therefore comprises the time less than or equal to 50 ms, the second buffer section the time greater than 50 ms and less than or equal to 100 ms, and so on. In the second line of FIG. 3, the respectively determined data connection parameter values of the call parameter GP2.A1 . . . . A14 (average volume) for the respective buffer section are indicated. For example, FIG. 3 contains the data connection parameter values GP2.A1=0, GP2.A2=0, GP2.A3=1, etc. The second line “GP2.A” thus contains the time-dependent data connection parameter values for the call parameter GP2. Correspondingly, the third line “GP2.T” contains the time-dependent telephone connection parameter values for the call parameter GP2 or the individual values GP2. T1=0, GP2. T2=2, GP2. T3=2 etc. The fourth line of FIG. 3 contains the difference between the respective parameter values, e.g. GP2.T1-GP2.A1, GP2.T2-GP2.A2, GP2.T3-GP2.A3 etc. Since the amounts of the difference values in the fourth line differ significantly from zero (i.e. are often above a threshold value of e.g. 1), no similarity may be determined for these telephone and data connections and for this offset of the parameter values and therefore no assignment of the respective telephone and data connections can be made.

In the example shown in FIG. 4, the time-dependent telephone connection parameter values GP2.t in the third line result from the values GP2.T from FIG. 3 with an offset of 1 buffer section (50 ms) to the right with respect to the data connection parameter values GP2.A from FIG. 3. The difference of the now superimposed parameter values indicated in the fourth line of FIG. 4, i.e. for example GP2.t2-GP2.A2=GP2.T1-GP2.A2, GP2.t3-GP2.A3=GP2. T2-GP2.A3, GP2.t4-GP2.A4=GP2.T3-GP2.A4 etc., fluctuates essentially around zero, so that a similarity may be detected for these parameter values with a detected temporal shift of 50 ms. The telephone connection of the first employee can therefore be assigned to the data connection for which the specified data connection parameter values GP2.A were determined.

With reference to FIGS. 5 to 9, another embodiment for comparing the determined time-dependent data connection parameter values for a particular data connection and the determined time-dependent telephone connection parameter values for the telephone connection of the first employee is now described. The data connection parameter values GP2.A determined analogously to the embodiment according to FIG. 3 are shown again for the respective buffer sections t in FIG. 5. The same applies to the telephone connection parameter values GP2.T listed in FIG. 3 for the respective buffer sections t, which are illustrated in FIG. 7. To achieve a quick and simple comparison of the parameter values, as already shown above, the parameter values GP2.A and GP2.T are processed in such a way that when a parameter value is changed, the number of buffer sections of the same length (e.g. 50 ms) over which the parameter value existed before the change is summarized for the respectively preceding buffer sections. This is shown in FIG. 6 for the data connection parameter values GP2.A of the call parameter GP2 and in FIG. 8 for the telephone connection parameter values GP2.T of the call parameter GP2. For example, a change in the data connection parameter value GP2.A from 0 to 1 is detected in the buffer section 100 ms<t≤150 ms. Accordingly, for the buffer section that begins at 0<t≤50 ms, it is recorded that the parameter value 0 was determined over 2 buffer sections of 50 ms in length (2×parameter value 0). In the buffer section 200 ms<t≤250 ms, a change in the data connection parameter value GP2.A from 1 to 0 is detected. Accordingly, for the buffer section that begins at 100<t≤150 ms, it is recorded that parameter value 1 was determined over 2 buffer sections of 50 ms in length (2×parameter value 1), etc. The line GP2.FA in FIG. 6 thus contains a certain summation or convolution of the line GP2.A shown in FIG. 5, in that the number of buffer sections and the respective parameter value that is constant over these buffer sections are specified (2×0, 2×1). The line “Ft1” illustrates the time period of the respective change in the parameter value. The time-dependent telephone connection parameter value GP2.T shown in FIG. 7 is processed in the same way. The result of this processing is shown as GP2.FT in the second line of FIG. 8. As in FIG. 6, the first line Ft2 contains the buffer section of the parameter value change.

The parameter values GP2.FA and GP2.FT are now compared both for the respective number of buffer sections determined for the constant parameter value and for the respective parameter value separately. In addition, the corresponding buffer section values of the parameter value change (Ft1 and Ft2) are compared. The comparison values (differences) are shown in FIG. 9. It can be seen that the differences of the buffer section values of the parameter value change, the differences of the parameter values and the differences in relation to the buffer section number deviate only slightly from zero, so that a similarity of the parameter values can be determined and therefore an assignment of the telephone connection of the first employee with the specific data connection may be made.

If no data connection for which the parameter values are equal to the parameter values of the telephone connection can be determined using the above procedure, the telephone connection is disconnected or another procedure is used for the assignment. Alternatively, the telephone call may continue without assignment and thus without the use of extended telecommunication functionalities of the telephone service provider or without the possibility of controlling these functionalities by the employee or user.

After the assignment of the individual telephone connection 24 to the data connection 27 of the employee 21 (e.g. employee b) by the telephone service provider 10, the telecommunication functionalities of the telephone service provider 10 may now be controlled by the employee 21 via the data connection 27. As an example of a telecommunication functionality, the employee 21, when telephoning with the user 31 via the telephone service provider 10, for example via another telephone service provider 40, 50 and 60, may activate, i.e. switch on or off, a recording device 14 at the telephone service provider 10 by a mouse click via the data connection 27. The recording device 14 is connected to the data processing unit 13 or integrated into the data processing unit 13 and (in both cases) connected to the data processing unit 23 of the employee 21 via the data processing unit 13 and via the data connection 27. Furthermore, the recording device 14 has a connection to the telephone connections 24, 34 with the employee 21 and the user 31 via the data processing unit 13. The employee 21 may therefore start and also stop a recording of a proportion of this telephone call during the telephone call of the employee 21 with the user 31 by a mouse click at his data processing unit 23. The forwarding of a telephone call or the setting up of a telephone conference by the telephone service provider 10 may also be initiated by the employee 21 via the data connection 27 and the data processing unit 23, for example by a mouse click.

The telephone call recorded by the recording device 14 may then be associated in the data processing unit 13 with another data relating to the telephone call, for example the date of the telephone call, the user 31, for example the name of the user 31 and his customer or contract number, and/or the employee 21, for example the name of the employee, and stored in a memory of the data processing unit 13 at the telephone service provider 10, for example in a database configured to do so.

A management system may then operate in the data processing unit 13 of the telephone service provider 10, which manages the call recordings made in this way.

Such call recordings may, for example, be generated and used as part of the opt-in procedure. In this context, a management system may, for example, inform the employee 21 with regard to the opt-in status for various media (telephone, SMS, fax), about missing opt-ins or about the expiry of opt-ins and initiate another steps, e.g. the timely obtaining of a user confirmation. It is also possible to include recordings in the telephone call between the employee 21 and a user 31.

The data collected by the telephone service provider 10, in particular call recordings, may also be transmitted to the company 20 for another use.

With the method according to the invention, it becomes possible for the first time for a telephone service provider 10 to make a simple and secure assignment of a data connection to a telephone connection without additional identifiers, which is carried out simply and cost-effectively in the background during the telephone call of the employee 21 with the user 31 automatically.

### LIST OF REFERENCE NUMERALS

1 Data network
2 Telephone network
10 Telephone service provider
13 Data processing unit of the telephone service provider 10
14 Recording device
20 Company
21 Employee
22 Telephone of the employee 21
23 Data processing unit of the employee 21
24 Telephone connection
24b Telephone connection
25 Telephone system
26 Recording device
27 Data connection
27b Data connection
31 User
32 Telephone of the user 31
34 Telephone connection
40 Telephone service provider
50 Telephone service provider
60 Telephone service provider

1. A method for communication of a telephone service provider with a first employee and plurality of another employees of a company in a communication network having a data network and a telephone network, wherein at the same time a plurality of data connections of the employees in each case to the telephone service provider via the data network and via a data processing unit assigned to the respective employee and a plurality of telephone connections of the employees to users via the telephone network and the telephone service provider exist, wherein the first employee holds a telephone call to a first user via a first telephone connection, comprising the following steps:
a) creating an audio recording of the first employee and/or the first user during the telephone call by a recording device connected to the data processing unit assigned to the first employee,
b) analyzing the created audio recording of the first employee and/or the first user with regard to at least one call parameter and determining time-dependent data connection parameter values for the at least one call parameter with regard to the first employee and/or the first user,
c) simultaneous analyzing the telephone call of the first employee with the first user transmitted via the telephone connection to the telephone service provider with regard to the at least one call parameter and determining time-dependent telephone connection parameter values relating to the at least one call parameter with respect to the first employee and/or the first user,
d) simultaneous performing steps a) and b) for further data connections of another employees without assignment and/or step c) for further telephone connections of another employees with another users without assignment, so that time-dependent data connection parameter values relating to the at least one call parameter exist in each case for the plurality of these data connections and/or time-dependent telephone connection parameter values relating to the at least one call parameter exist in each case for the plurality of these telephone connections with respect to the respective employee and/or user,
e) comparing the determined time-dependent telephone connection parameter values for the at least one call parameter of the telephone connection of the first employee and, if applicable, of the plurality of another telephone connection with the determined time-dependent data connection parameter values for the at least one call parameter of the telephone call of the first employee and, if applicable, the plurality of another data connection,
f) assigning the telephone connection of the first employee and, if applicable, the telephone connections of another employees in each case to a data connection based on the results of the comparisons specified in step e).

2. The method according to claim 1, wherein the at least one conversation parameter represents a parameter comprising predetermined words, the speech rhythm, the volume level, the pitch, a dominant frequency and/or emotions.

3. The method according to claim 1, wherein the time-dependent telephone connection parameter values and the time-dependent data connection parameter values are compared at least twice by the telephone service provider, wherein in the second comparison the telephone connection parameter values and the data connection parameter values are offset in time from each other by a predetermined time interval with respect to the first comparison.

4. The method according to claim 1, wherein, in addition, the respective duration of a data connection parameter value being constant and of a telephone connection parameter value being constant over the course of the telephone call is included in the comparison according to step e).

5. The method according to claim 1, wherein during the analysis with regard to the call parameters, the call data is processed in such a way that it is impossible to draw conclusions about the content of the telephone call.

6. The method according to claim 2, wherein the speech rhythm is determined by determining the temporal position and length of pauses between the words spoken.

7. The method according to claim 1, wherein the comparison of the temporal courses of the telephone connection parameter values and of the data connection parameter values is carried out in each case separately for the employee and the user.

8. The method according to claim 1, wherein the comparison is made over a minimum period of time and/or in that a predetermined number of call parameters is used for the comparison and/or call parameter-individual matching criteria between the temporal courses of the data connection parameter values and the telephone connection parameter values are taken into account.

9. The method according to claim 1, wherein telecommunication functionalities of the telephone service provider are controlled by the first employee via the respective data connection to the telephone service provider assigned to the telephone connection of the first employee.

10. The method according to claim 1, wherein in the case that none of the plurality of data connections to the telephone service provider can be assigned to the telephone connection of the first employee, the telephone connection to the first employee is interrupted.

11. A data processing unit for use by a telephone service provider for communication with a first employee and a plurality of another employees of a company in a communication network having a data network and a telephone network, wherein at the same time a plurality of data connections of the employees, including the first employee, are established via the data network, in each case to the telephone service provider and a telephone connection from the telephone of the first employee and, if applicable, of a plurality of another employees of the company to the telephone service provider via the telephone network can be established, wherein a telephone call can be made by the first employee via the telephone connection to a first user and by the another employee to another user, wherein the data processing unit is configured to carry out the method according to claim 1.

12. A computer program product for communication of a telephone service provider with a first employee and a plurality of another employees of a company in a communication network having a data network and a telephone network comprising instructions which, when executed by one or more processors, cause the respective processor to perform the steps of the method according to claim 1.

13. A computer readable data carrier storing a computer program product according to claim 12.
